(19) United States
(12) Patent Application Publication
(10) Pub. No.: US 2024/0000017 A1
(43) Pub. Date: Jan. 4, 2024

(54) AIR DELIVERY SYSTEM FOR ASSISTING GRAIN CROP HARVESTING

(71) Applicants: Mark MACDONALD, Egmondville (CA); Ian BROWN, Stratford (CA); Michael DECORTE, Bayfield (CA)

(72) Inventors: Mark MACDONALD, Egmondville (CA); Ian BROWN, Stratford (CA); Michael DECORTE, Bayfield (CA)

(73) Assignee: TEMP FARM EQUIPMENT LTD., Mitchell, ON (CA)

(21) Appl. No.: 18/207,988

(22) Filed: Jun. 9, 2023

(30) Foreign Application Priority Data
Jun. 30, 2022 (CA) 3166180

(51) Int. Cl. A01D 57/10; A01D 57/02; A01D 41/14

(52) U.S. Cl. CPC A01D 57/10; A01D 57/02; A01D 41/142

(57) ABSTRACT

A pressurized air delivery system for assisting grain crop harvesting. The system includes a left hand side manifold and a right hand side manifold adapted for being mounted to a harvester header. Each manifold is connected to a plurality of nozzles disposed along the respective manifold. Each manifold is adapted for receiving a pressurized air flow at a first end thereof and for providing the pressurized air flow to the nozzles. Each manifold is closed at a second opposite end thereof. The left hand side manifold and the right hand side manifold span approximately from a left hand side of the harvester header to a right hand side of the harvester header. An air flow source provides the pressurized air flow. An air conduit is connected to: the air flow source; the first end of the left hand side manifold; and the first end of the right hand side manifold. The air conduit comprises a divider for: receiving the pressurized air flow from the air flow fan; dividing the pressurized air flow; and providing the divided pressurized air flow to the left hand side manifold and the right hand side manifold.

This application claims priority to Canadian Patent Application No. 3,166,180 entitled Air Delivery System For Assisting Grain Crop Harvesting filed on Jun. 30, 2022, the entire contents of which are hereby incorporated by reference.

### FIELD

The present disclosure relates to grain crop harvesting technology, and more particularly to a pressurized air delivery system for assisting grain crop harvesting by providing a pressurized air flow to assist cutting of grain crop and delivery of the cut grain crop towards a feeder house of a combine harvester.

### BACKGROUND

Present-day grain crop harvesters utilize a combine harvester having a harvesting header mounted to a front end thereof. Harvesting headers are provided in different forms adapted for harvesting different grain crops and, in particular, for cutting the grain crop and/or handling the cut grain crop. From the header the grain crop is then delivered to the feeder house of the combine for transporting the same to the thrashing area where the usable grain crop is separated from stalks, vines, etc.

Since the 1980s systems have been devised for delivering a pressurized air flow to assist the cutting of the grain crop and for delivery of the cut grain crop towards the feeder house of the combine harvester. Pressurized air is provided through nozzles placed in proximity to the ground to situate the grain crop optimally for cutting and to advance the cut grain crop at a continuous flow volume to the feeder house of the combine for further processing.

Present-day harvester headers have a substantial span between the left hand side and right hand side thereof ranging from 30 ft to 60 ft. In order for the delivery of the pressurized air flow to work effectively, it is necessary that the air streams exiting the nozzles are substantially the same across the complete width of the harvester header, i.e. the air flow pressure has to be substantially constant across the complete width of the harvester header. Variations in the air pressure results in uneven grain crop delivery and/or localized accumulation and, consequently in inefficient combine operation and loss of usable grain crop.

Different designs of air delivery system have been devised and are currently in use. In a first design, a single air flow fan provides the air flow to a single manifold with associated nozzles extending along the complete span of the harvester header. Unfortunately, such an arrangement results in a substantial variation of the air flow pressure along the manifold extending along the large span of the present-day harvester headers.

In order to overcome this drawback another design utilizes two separate air flow fans with each being connected to a respective manifold extending half the span of the harvester header. Unfortunately, this design results in a substantially more complicated and cost intensive system requiring two air flow fans to be mounted to the harvester header and connected to the drive means of the combine. Furthermore, the two separate air flow fans draw substantially more power from the combine than a single air flow fan which can compromise the combine's ability to operate efficiently. Yet further, there might still be some variation in the air flow pressure since the two separate air flow fans must be synchronized which is difficult to achieve and maintain.

In a third design, as disclosed in U.S. Pat. Nos. 9,462,750 and 9,480,203, a manifold extending the complete width of the harvester header is provided with an air flow from both ends via tubing forming a closed loop which is connected to a single air flow fan via a “T” or “Y” connector. Unfortunately, also this design results in a variation of air flow pressure along the manifold requiring a baffle being disposed in the manifold. Furthermore, the provision of the air flow from both ends of the manifold results in turbulence due to the merging air flows, thus causing substantial losses in the air flow.

It may be desirable to provide an air delivery system for assisting grain crop harvesting that is capable of providing an air flow having a substantially constant air pressure across the span of the harvester header.

It also may be desirable to provide an air delivery system for assisting grain crop harvesting that is simple and cost efficient.

It also may be desirable to provide an air delivery system for assisting grain crop harvesting that utilizes a single air flow fan.

It also may be desirable to provide an air delivery system for assisting grain crop harvesting that has substantially reduced air flow losses.

### SUMMARY

Accordingly, one advantage of the present disclosure is to provide an air delivery system for assisting grain crop harvesting that is capable of providing an air flow having a substantially constant air pressure across the span of the harvester header.

Another advantage of the present disclosure is to provide an air delivery system for assisting grain crop harvesting that is simple and cost efficient.

Another advantage of the present disclosure is to provide an air delivery system for assisting grain crop harvesting that utilizes a single air flow fan.

Another advantage of the present disclosure is to provide an air delivery system for assisting grain crop harvesting that has substantially reduced air flow losses.

According to one aspect of the present disclosure, there is provided a pressurized air delivery system for assisting grain crop harvesting. The system comprises a left hand side manifold and a right hand side manifold adapted for being mounted to a harvester header. Each manifold is connected to a plurality of nozzles disposed along the respective manifold. Each manifold is adapted for receiving a pressurized air flow at a first end thereof and for providing the pressurized air flow to the nozzles. Each manifold is closed at a second opposite end thereof. The left hand side manifold and the right hand side manifold span approximately from a left hand side of the harvester header to a right hand side of the harvester header. An air flow source provides the pressurized air flow. An air conduit is connected to: the air flow source; the first end of the left hand side manifold; and the first end of the right hand side manifold. The air conduit comprises a divider for: receiving the pressurized air flow from the air flow fan; dividing the pressurized air flow; and providing the divided pressurized air flow to the left hand side manifold and the right hand side manifold.

According to one aspect of the present disclosure, there is provided a pressurized air delivery system for assisting grain crop harvesting. The system comprises a left hand side manifold and a right hand side manifold adapted for being mounted to a harvester header. Each manifold is connected to a plurality of nozzles disposed along the respective manifold. Each manifold is adapted for receiving a pressurized air flow at a first end thereof and for providing the pressurized air flow to the nozzles. Each manifold is closed at a second opposite end thereof. The left hand side manifold and the right hand side manifold span approximately from a left hand side of the harvester header to a right hand side of the harvester header. An air flow source provides the pressurized air flow. An air conduit is connected to: the air flow source; the first end of the left hand side manifold; and the first end of the right hand side manifold. The air conduit comprises a divider for: receiving the pressurized air flow from the air flow fan; dividing the pressurized air flow; and providing the divided pressurized air flow to the left hand side manifold and the right hand side manifold. The first end of the left hand side manifold is placed in proximity to the left hand side of the harvester header and the first end of the right hand side manifold is placed in proximity to the right hand side of the harvester header. The air conduit comprises a left hand side air conduit section interposed between the divider and the left hand side manifold and a right hand side air conduit section interposed between the divider and the right hand side manifold.

According to an aspect, there is provided a pressurized air delivery system for assisting grain crop harvesting. The system comprises a left hand side manifold and a right hand side manifold adapted for being mounted to a harvester header. Each manifold is connected to a plurality of nozzles disposed along the respective manifold. Each manifold is adapted for receiving a pressurized air flow at a first end thereof and for providing the pressurized air flow to the nozzles. Each manifold is closed at a second opposite end thereof. The left hand side manifold and the right hand side manifold span approximately from a left hand side of the harvester header to a right hand side of the harvester header. An air flow source provides the pressurized air flow. An air conduit is connected to: the air flow source; the first end of the left hand side manifold; and the first end of the right hand side manifold. The air conduit comprises a divider for: receiving the pressurized air flow from the air flow fan; dividing the pressurized air flow; and providing the divided pressurized air flow to the left hand side manifold and the right hand side manifold. The second end of the left hand side manifold is placed in proximity to the left hand side of the harvester header and the second end of the right hand side manifold is placed in proximity to the right hand side of the harvester header. The divider is directly connected to the first end of the left hand side manifold and to the first end of the right hand side manifold.

According to an aspect, there is provided a pressurized air delivery system for assisting grain crop harvesting. The system comprises a left hand side manifold and a right hand side manifold adapted for being mounted to a harvester header. Each manifold is connected to a plurality of nozzles disposed along the respective manifold. Each manifold is adapted for receiving a pressurized air flow at a first end thereof and for providing the pressurized air flow to the nozzles. Each manifold is closed at a second opposite end thereof. The left hand side manifold and the right hand side manifold span approximately from a left hand side of the harvester header to a right hand side of the harvester header. An air flow source provides the pressurized air flow. An air conduit is connected to: the air flow source; the first end of the left hand side manifold; and the first end of the right hand side manifold. The air conduit comprises a divider for: receiving the pressurized air flow from the air flow fan; dividing the pressurized air flow; and providing the divided pressurized air flow to the left hand side manifold and the right hand side manifold. The first end of the left hand side manifold and the first end of the right hand side manifold both face the left hand side of the harvester header or the right hand side of the harvester header.

An advantage of the present disclosure is that it provides an air delivery system for assisting grain crop harvesting that is capable of providing an air flow having a substantially constant air pressure across the span of the harvester header.

A further advantage of the present disclosure is that it provides an air delivery system for assisting grain crop harvesting that is simple and cost efficient.

A further advantage of the present disclosure is that it provides an air delivery system for assisting grain crop harvesting that utilizes a single air flow fan.

A further advantage of the present disclosure is that it provides an air delivery system for assisting grain crop harvesting that has substantially reduced air flow losses.

### BRIEF DESCRIPTION OF THE DRAWINGS

An embodiment of the present disclosure is described below with reference to the accompanying drawings, in which:

FIG. 1a is a simplified block diagram illustrating in a top perspective view a pressurized air delivery system for assisting grain crop harvesting according to a first embodiment;

FIG. 1b is a simplified block diagram illustrating in top perspective view details of the pressurized air delivery system for assisting grain crop harvesting according to the first embodiment;

FIG. 1c is a simplified block diagram illustrating in top perspective view details of the pressurized air delivery system for assisting grain crop harvesting according to the first embodiment;

FIG. 1d is a simplified block diagram illustrating in top perspective view details of the pressurized air delivery system for assisting grain crop harvesting according to the first embodiment;

FIG. 1e is a simplified block diagram illustrating in a top view the pressurized air delivery system for assisting grain crop harvesting according to the first embodiment;

FIG. 2a is a simplified block diagram illustrating in a top perspective view a pressurized air delivery system for assisting grain crop harvesting according to a second embodiment;

FIG. 2b is a simplified block diagram illustrating in a top view a pressurized air delivery system for assisting grain crop harvesting according to the second embodiment;

FIG. 3a is a simplified block diagram illustrating in a top perspective view a pressurized air delivery system for assisting grain crop harvesting according to a third embodiment;

FIG. 3b is a simplified block diagram illustrating in a top perspective view a detail of the pressurized air delivery system for assisting grain crop harvesting according to the third embodiment;

FIG. 3c is a simplified block diagram illustrating in a top view the pressurized air delivery system for assisting grain crop harvesting according to the third embodiment;

FIG. 4a is a simplified block diagram illustrating in a top perspective view a pressurized air delivery system for assisting grain crop harvesting according to a fourth embodiment;

FIG. 4b is a simplified block diagram illustrating in a top perspective view a detail of the pressurized air delivery system for assisting grain crop harvesting according to the fourth embodiment; and,

FIG. 5 is a simplified block diagram illustrating in a top view the pressurized air delivery system for assisting grain crop harvesting according to a fifth embodiment.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

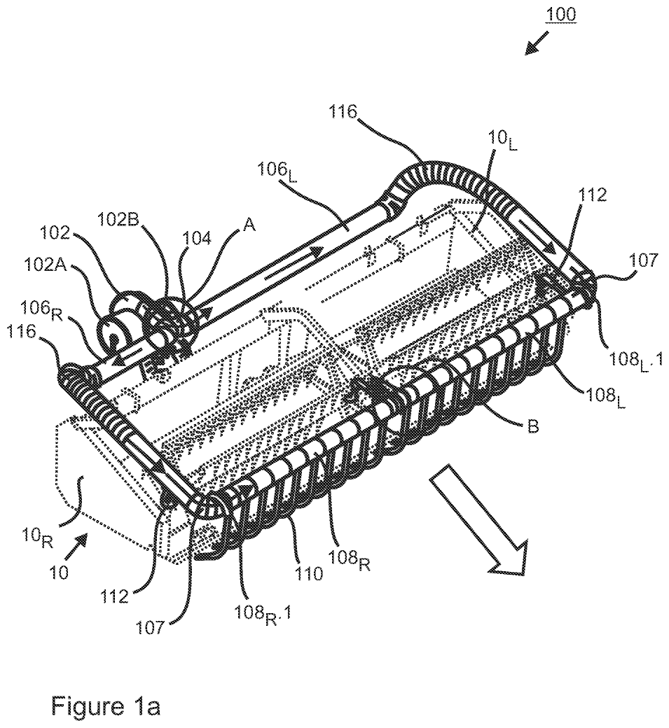

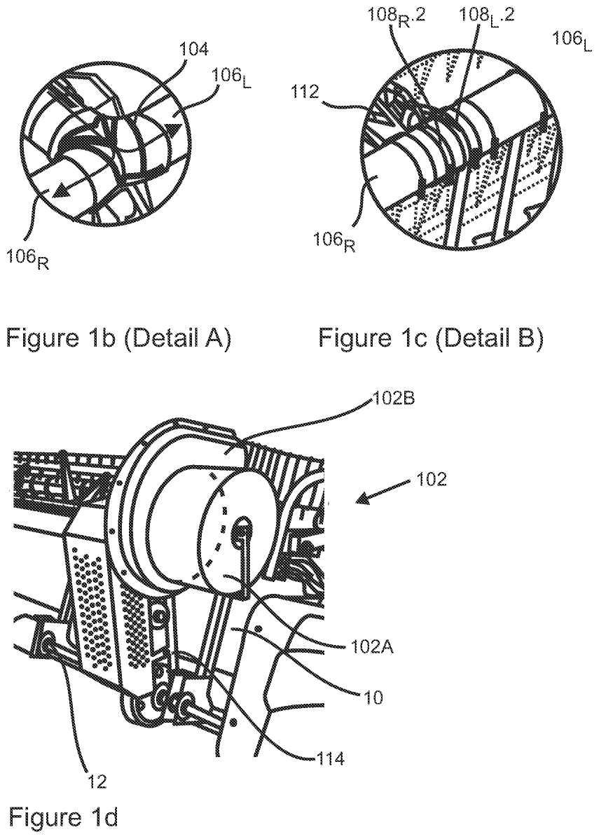

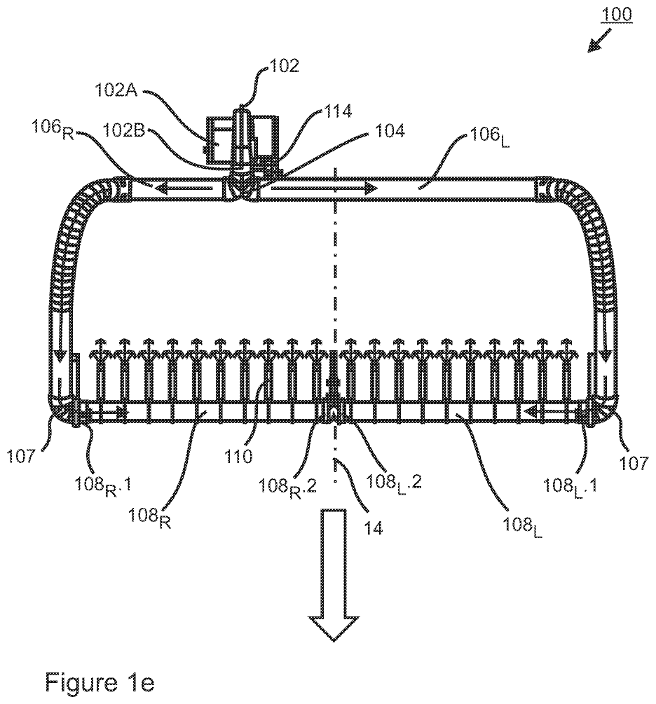

Referring to FIGS. 1a to 1e a pressurized air delivery system 100 for assisting grain crop harvesting according to a first embodiment is provided. The pressurized air delivery system 100 is adapted for being mounted to a harvester header 10 via, for example, mounting brackets 112, of a combine harvester. It is noted that only the harvester header 10 of the combine harvester is illustrated in the Figures for simplicity. The pressurized air delivery system 100 comprises a left hand side manifold 108_{L} and a right hand side manifold 108_{R} disposed at a front end of the harvester header 10 in a forward moving direction of the combine harvester, as indicated by the block arrows in FIGS. 1a and 1e.

Each manifold 108_{L},108_{R} is connected to a plurality of nozzles 110 disposed along the respective manifold 108_{L},108_{R}. Each manifold 108_{L},108_{R} receives a pressurized air flow at a first end 108_{L}.1, 108_{R}.1 thereof and provides the pressurized air flow to the nozzles 110. The nozzles 110 are placed in proximity to the ground such that the pressurized air flow exiting the nozzles 110 is directed towards the head cutting knife to situate the grain crop optimally for cutting and to advance the cut grain crop at a continuous flow volume to the feeder house of the combine. Each manifold 108_{L},108_{R} is closed at a second opposite end 108_{L}.2, 108_{R}.2 thereof via, for example, an end cap mounted thereto. The left hand side manifold 108_{L} and the right hand side manifold 108_{R} span approximately from a left hand side 10_{L} of the harvester header 10 to a right hand side 10_{R} of the harvester header 10.

The pressurized air flow is generated by air flow source 102 such as, for example, a conventional centrifugal air flow fan assembly, mounted to the harvester header 10. The air flow source 102 comprises an air inlet 102A for receiving ambient air and an air outlet 102B for providing the pressurized air flow.

The pressurized air flow is provided to the first end 108_{L}.1 of the left hand side manifold 108_{L} and the first end 108_{R}.1 of the right hand side manifold 108_{R} via an air conduit connected to the air outlet 102B of the air flow source 102. The air conduit comprises a divider 104 for: receiving the pressurized air flow from the air flow fan; dividing the pressurized air flow; and providing the divided pressurized air flow to the left hand side manifold 108_{L} and the right hand side manifold 108_{R}, as indicated by the arrows in FIGS. 1a, 1b and 1e. The divider 104 can be “Y” shaped, as illustrated in detail A in FIG. 1b. Alternatively, a different divider such as, for example, a “T” shaped divider may be employed.

As illustrated in FIG. 1a, the first end 108_{L}.1 of the left hand side manifold 108_{L} is placed in proximity to the left hand side 10_{L} of the harvester header 10 and the first end 108_{R}.1 of the right hand side manifold 108_{R} is placed in proximity to the right hand side 10_{R} of the harvester header 10, thus the pressurized air flow in the manifolds is directed towards a center 14 of the harvester header 10 where the closed or capped ends 108_{L}.2, 108_{R}.2 of the manifolds 108_{L}, 108_{R} are placed, as illustrated in the detail B in FIG. 1c. The pressurized air flow is divided in divider 104, which is, in one case, directly connected to the outlet 102B of the air flow source 102, and provided to the left hand side manifold 108_{L} and the right hand side manifold 108_{R} via left hand side air conduit section 106_{L} and right hand side air conduit section 106_{R}, respectively. The air conduit sections 106_{L} and 106_{R} can be connected to the respective manifolds 108_{L} and 108_{R} via elbow elements 107. The air conduit sections 106_{L} and 106_{R} can each comprise flexible portions 116 such as, for example, a flexible hose, to enable movement of the manifolds 108_{L} and 108_{R} with changes in the reel position of the harvester header 10.

The pressurized air delivery system 100 is easily adapted for being mounted to various harvester headers 10 with the air flow source 102 being placed, for example, between the center 14 and the right hand side 10_{R} of the harvester header 10, as illustrated in FIGS. 1a and 1e, or alternatively, between the center 14 and the left and side 10_{L} of the harvester header 10. The air flow source 102 can be connected to a power drive mechanism 12 of the combine having the harvester header 10 mounted thereto via a conventional belt drive 114, as illustrated in FIG. 1d.

Optionally, the manifolds 108_{L} and 108_{R} may be provided having different lengths to compensate for different pressure losses of the air flow due to different lengths of the air conduit sections 106_{L} and 106_{R}.

The pressurized air delivery system 100 is capable of providing an air flow having a substantially constant air flow pressure along large spans of present-day harvester headers 10. By utilizing a single air flow fan 102 the pressurized air delivery system 100 is simple and cost efficient, while also overcoming synchronization problems encountered when employing two air flow fans. Furthermore, air flow losses are substantially reduced compared to prior art systems by reducing the average air velocity in the manifolds and/or reducing turbulence, for example, caused by re-merging air flows in different directions.

In an example implementation, the pressurized air delivery system 100 has been adapted for being mounted to combine harvester headers 10 having a span between 30 ft and 60 ft with the number of nozzles 110 varying between 30 and 60. The manifolds 108_{L} and 108_{R} and the flexible hose 116 have a diameter between 8″ and 10″, while the nozzles 110 have a diameter between 1.25″ and 1.5″. The pressurized air delivery system 100 has been designed to operate at an air flow rate between 4000 scfm and 6000 scfm at an air pressure between 20″ H₂O and 35″ H₂O. The manifolds 108_{L} and 108_{R} have been manufactured from extruded aluminum, while the nozzles 110 have been made of extruded or formed aluminum tubing with die-cast aluminum mounting saddles. The mounting brackets 112 have been made of fabricated/welded steel. The flexible hose 116 has been made of a Urethane compound with steel wire reinforcement.

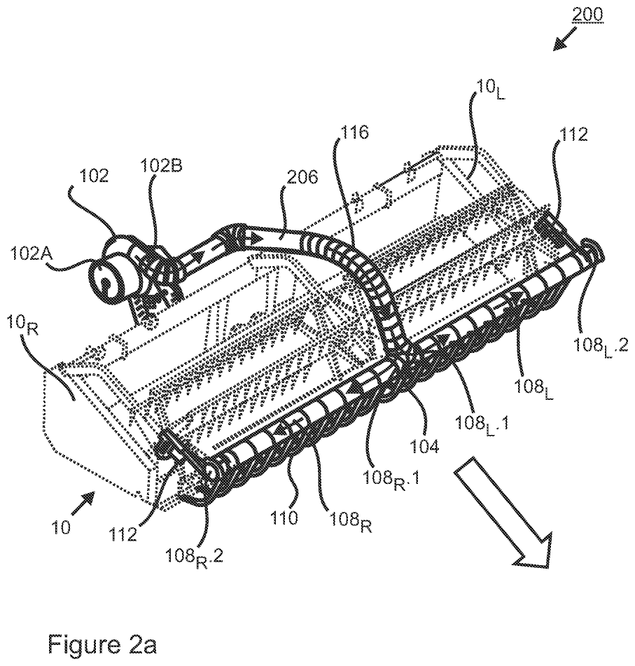

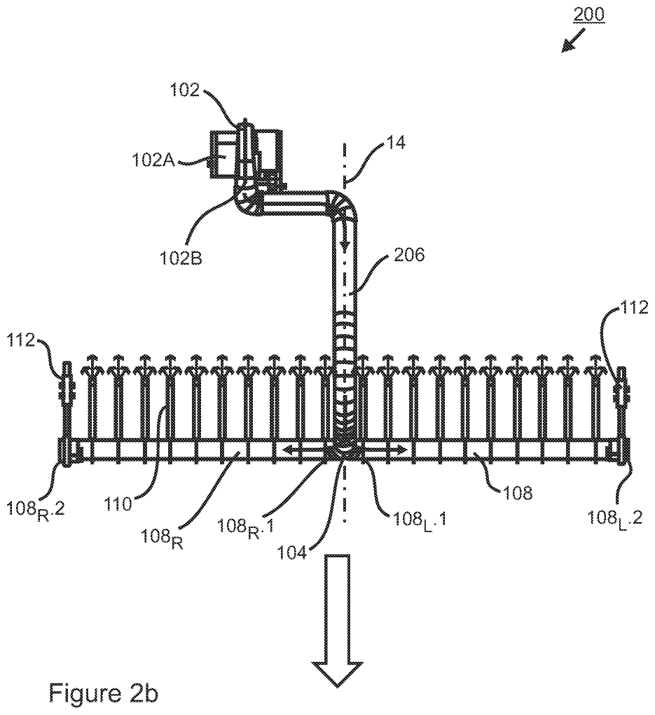

Referring to FIGS. 2a and 2b a pressurized air delivery system 200 for assisting grain crop harvesting according to a second embodiment is provided. The system 200 comprises substantially the same components as the system 100 with same reference numerals used for same components. The system 200 differs from the system 100 in the different orientation of the manifolds 108_{L} and 108_{R} and a different air conduit. Here, the second end 108_{L}.2 of the left hand side manifold 108_{L} is placed in proximity to the left hand side 10_{L} of the harvester header 10 and the second end 108_{R}.2 of the right hand side manifold 108_{R} is placed in proximity to the right hand side 10_{R} of the harvester header 10.

Depending on the design of the harvester header 10 the air flow source 102 is placed, for example, between the center 14 and the right hand side 10_{R} of the harvester header 10, as illustrated in FIGS. 2a and 2b, or the center 14 and the left hand side 10_{L} of the harvester header 10. The divider 104 can be placed approximately at the center 14 of the harvester header 10 and directly connected to the first end 108_{L}.1 of the left hand side manifold 108_{L} and to the first end 108_{R}.1 of the right hand side manifold 108_{R}, thus the pressurized air flow in the manifolds is directed outwards from the center 14 towards the left hand side 10_{L} and the right hand side 10_{R} of the harvester header 10 where the closed, or capped, ends 108_{L}.2, 108_{R}.2 of the manifolds 108_{L}, 108_{R} are placed. Connecting air conduit section 206 is interposed between the divider 104 and the outlet 102B of the air flow source 102. The air conduit section 206 can comprise a flexible hose portions 116 to enable movement of the manifolds 108_{L} and 108_{R} with changes in the reel position of the harvester header 10.

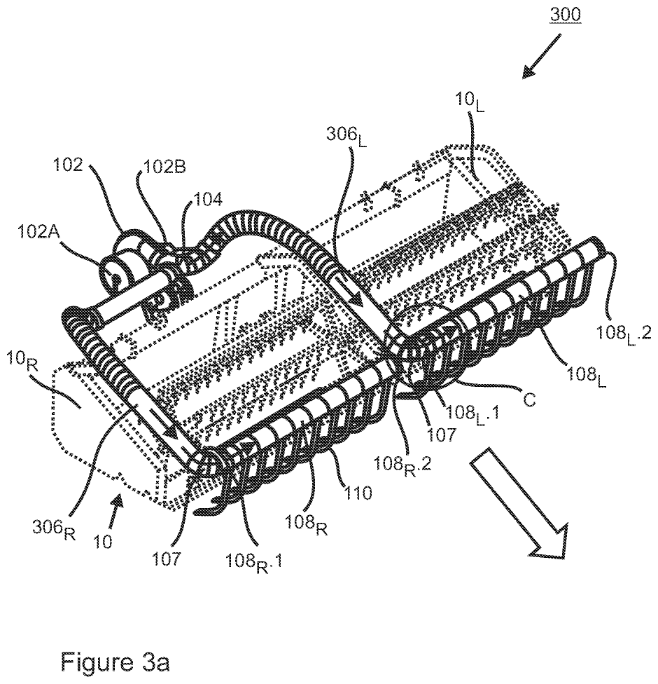

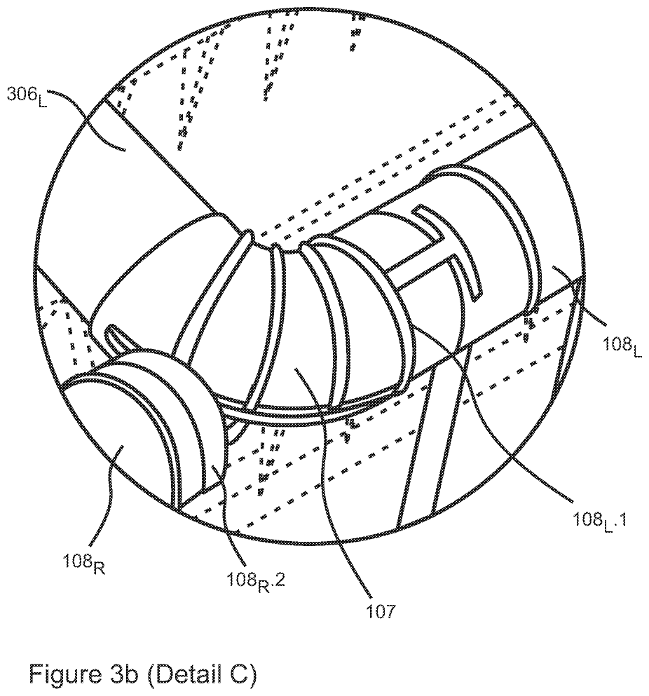

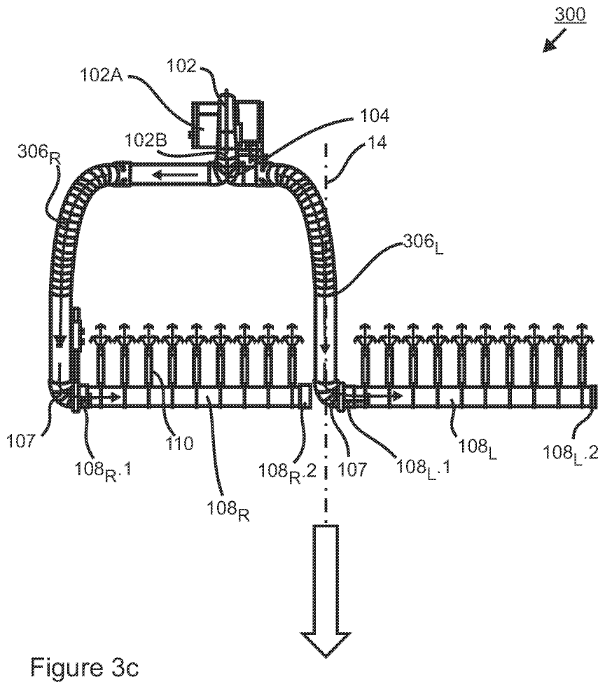

Referring to FIGS. 3a to 3c a pressurized air delivery system 300 for assisting grain crop harvesting according to a third embodiment is provided. The system 300 comprises substantially the same components as the systems 100 and 200 with same reference numerals used for same components. The system 300 differs from the systems 100 and 200 in the different orientation of the manifolds 108_{L} and 108_{R} and a different air conduit. Here, the first end 108_{L}.1 of the left hand side manifold 108_{L} and the first end 108_{R}.1 of the right hand side manifold 108_{R} both face the right hand side 10_{R} of the harvester header 10, as illustrated in FIGS. 3a and 3c, or, alternatively, the left hand side 10_{L} of the harvester header 10.

The divider 104 can be directly connected to the outlet 102B of the air flow fan 102. Air conduit sections 306_{L} and 306_{R} are interposed between the divider 104 and the first end 108_{L}.1 of the left hand side manifold 108_{L} and the first end 108_{R}.1 of the right hand side manifold 108_{R}, respectively, thus the pressurized air flow in the manifolds is directed towards the left hand side 10_{L} of the harvester header 10 where the closed or capped ends 108_{L}.2, 108_{R}.2 of the manifolds 108_{L}, 108_{R} are placed. The air conduit sections 306_{L} and 306_{R} can be connected to the respective manifolds 108_{L} and 108_{R} via elbow elements 107. The air conduit sections 306_{L} and 306_{R} can each comprise a flexible hose portion 116 to enable movement of the manifolds 108_{L} and 108_{R} with changes in the reel position of the harvester header 10.

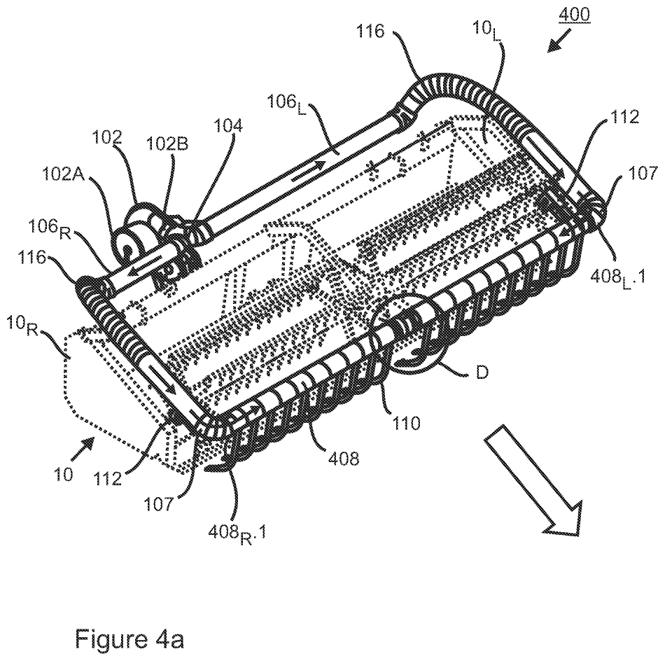

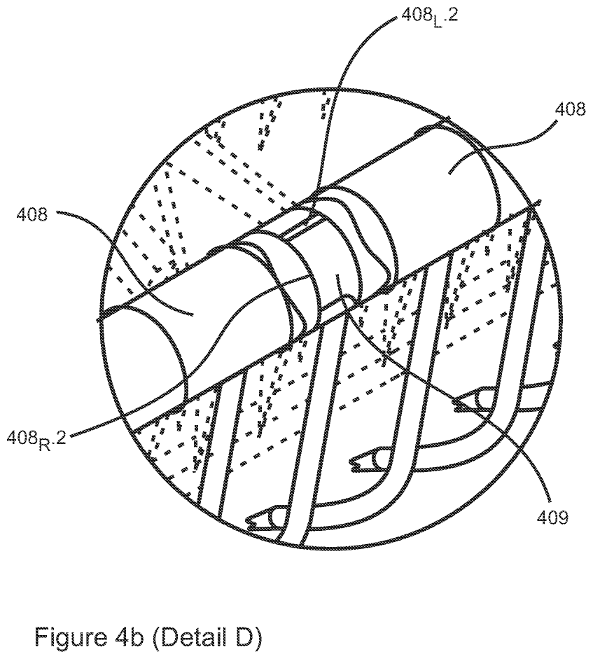

Referring to FIGS. 4a and 4b a pressurized air delivery system 400 for assisting grain crop harvesting according to a fourth embodiment is provided. The system 400 comprises substantially the same components as the system 100 with same reference numerals used for same components. The system 400 differs from the system 100 in the replacement of the left hand side manifold 108_{L} and the right hand side manifold 108_{R} with a single manifold 408 spanning between a left hand side first end 408_{L}.1 and a right hand side first end 408_{R}.1 from the left hand side 10_{L} of the harvester header 10 to a right hand side 10_{R} of the harvester header 10. Manifold divider 409 is disposed at the center of the manifold 408 blocks the left hand side air flow at 408_{L}.2 and the right hand side air flow at 408_{R}.2.

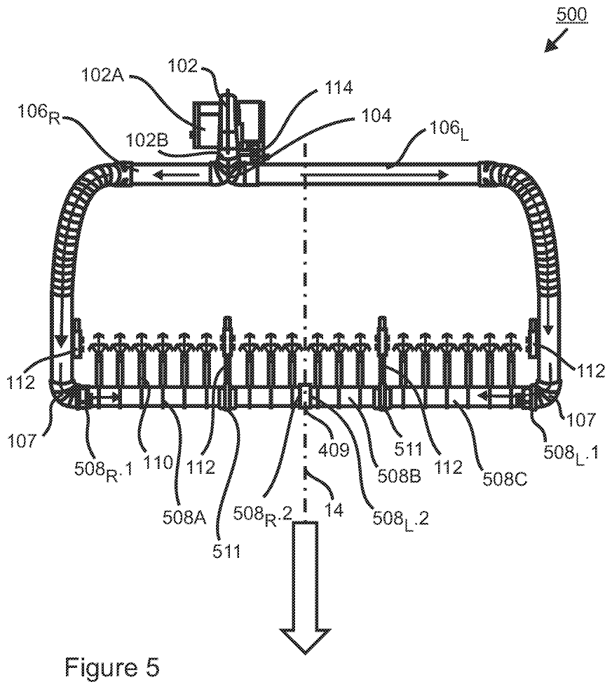

Referring to FIG. 5 a pressurized air delivery system 500 for assisting grain crop harvesting according to a fifth embodiment is provided. The system 500 comprises substantially the same components as the system 400 with same reference numerals used for same components. The system 500 comprises a single manifold 508 spanning between a left hand side first end 508_{L}.1 and a right hand side first end 508_{R}.1 from the left hand side 10_{L} of the harvester header 10 to a right hand side 10_{R} of the harvester header 10. Manifold divider 409 is disposed at the center of the manifold 508 blocks the left hand side air flow at 508_{L}.2 and the right hand side air flow at 508_{R}.2. Here, the manifold 508 is divided into a plurality of sections, for example, three sections 508A, 508B, and 508C, as illustrated in FIG. 5, but is not limited thereto. The three sections 508A, 508B, and 508C are connected via flexible couplers 511 interposed therebetween. The flexible couplers 511 may be made of, for example, a Urethane compound with steel wire reinforcement.

It is noted that the concept of dividing a manifold into a plurality of sections and connecting the sections with flexible couplers may also be employed in the pressurized air delivery systems 100, 200 and 300 hereinabove.

The pressurized air delivery systems 200 to 500 provide the same advantages and are implementable in a similar manner as the pressurized air delivery systems 100 described hereinabove.

The present invention has been described herein with regard to certain embodiments. However, it will be obvious to persons skilled in the art that a number of variations and modifications can be made without departing from the scope of the invention as described herein.

What is claimed is:

1. A pressurized air delivery system for assisting grain crop harvesting comprising:
a left hand side manifold and a right hand side manifold adapted for being mounted to a harvester header, each manifold being connected to a plurality of nozzles disposed along the respective manifold, each manifold being adapted for receiving a pressurized air flow at a first end thereof and for providing the pressurized air flow to the nozzles, each manifold being closed at a second opposite end thereof, the left hand side manifold and the right hand side manifold spanning approximately from a left hand side of the harvester header to a right hand side of the harvester header;
an air flow source for providing the pressurized air flow; and,
an air conduit connected to: the air flow source; the first end of the left hand side manifold; and the first end of the right hand side manifold, the air conduit comprising a divider for: receiving the pressurized air flow from the air flow fan; dividing the pressurized air flow; and providing the divided pressurized air flow to the left hand side manifold and the right hand side manifold.

2. The system according to claim 1 wherein the first end of the left hand side manifold is placed in proximity to the left hand side of the harvester header and the first end of the right hand side manifold is placed in proximity to the right hand side of the harvester header, or
wherein the second end of the left hand side manifold is placed in proximity to the left hand side of the harvester header and the second end of the right hand side manifold is placed in proximity to the right hand side of the harvester header, or
wherein the first end of the left hand side manifold and the first end of the right hand side manifold both face the left hand side of the harvester header or the right hand side of the harvester header.

3. The system according to claim 2 wherein the air conduit comprises a “Y” or a “T” shaped divider for dividing the pressurized air flow.

4. The system according to claim 3 wherein the divider is directly connected to the first end of the left hand side manifold and to the first end of the right hand side manifold.

5. The system according to claim 3 wherein the divider is directly connected to an outlet of the air flow source.

6. The system according to claim 5 wherein the air conduit comprises a left hand side air conduit section interposed between the divider and the left hand side manifold and a right hand side air conduit section interposed between the divider and the right hand side manifold.

7. The system according to claim 6 wherein the left hand side air conduit section and the right hand side air conduit section each comprise an elbow element connected to the respective manifold.

8. The system according to claim 3 wherein the air flow source is placed between a center and the left hand side of the harvester header or the center and the right hand side of the harvester header.

9. The system according to claim 8 wherein the divider is placed between a center and the left hand side of the harvester header or the center and the right hand side of the harvester header.

10. The system according to claim 8 wherein the divider is placed approximately at a center of the harvester header.

11. The system according to claim 10 wherein the air flow source is placed between a center and the left hand side of the harvester header or the center and the right hand side of the harvester header and wherein a connecting air conduit section is interposed between the divider and an outlet of the air flow source.

12. The system according to claim 1 wherein the air conduit and the manifolds are adapted for being mounted to the harvester header.

13. The system according to claim 12 wherein the air flow source is adapted for being mounted to the harvester header.

14. The system according to claim 13 wherein the air flow source comprises a centrifugal air flow fan assembly.

15. The system according to claim 13 wherein the air flow source is adapted for being driven by a power drive mechanism of a combine having the harvester header mounted thereto.

16. The system according to claim 15 wherein the air flow source is connected to the power drive mechanism of the combine via a belt drive.

17. The system according to claim 12 wherein the air conduit comprises at least a flexible hose portion to enable movement of the manifolds with changes in a reel position of the harvester header.
